(19) United States
(12) Patent Application Publication
(10) Pub. No.: US 2010/0084910 A1
(43) Pub. Date: Apr. 8, 2010

(54) Wheel

(76) Inventors: Daniel Rudolf Jansen Botes, Tzaneen (ZA); Keith Alexander Smit, Tzaneen (ZA)

Correspondence Address: RADER, FISHMAN & GRAUER PLLC, 10653 SOUTH RIVER FRONT PARKWAY, SUITE 150, SOUTH JORDAN, UT, 84095, US

(21) Appl. No.: 12/513,356

(22) PCT Filed: Nov. 2, 2007
(86) PCT No.: PCT/IB2007/054445

§ 371 Date: May 1, 2009

(30) Foreign Application Priority Data
Nov. 3, 2006 (ZA) 200609177

(51) Int. Cl. B60B 15/26; B60B 15/24; B22C 9/28; B29C 39/10

(52) U.S. Cl. 301/86; 301/89; 249/56; 264/262

(57) ABSTRACT

The invention provides a heavy duty rim assembly (10) for use with a moulded or cast non-inflatable tyre, a wheel (100) including such a rim assembly and tyre (102), a mould (200) for such a tyre, and a method of manufacturing such a wheel. The rim assembly includes a nave (12) for mounting on a vehicle axle, a hollow barrel (14) around the nave, and a plurality of key members (16) around the barrel. The key members, in use, provide for effective bonding and keying of the rim assembly with the non-inflatable tyre. The key members define a belt (46) around the barrel, the belt being at least substantially concentric with and spaced apart from the barrel. The key members define holes (36) therethrough for tyre material to extend through in a completed wheel.

THIS INVENTION relates to a wheel. It relates in particular to a wheel for a heavy vehicle, the wheel including a rim assembly and a non-inflatable tyre. It relates also to a method of manufacturing such a wheel and to a mould for use in such a method.

The Inventors believe that non-inflatable tyres for wheels of heavy duty vehicles have advantages over pneumatic tyres, particularly so for very heavy vehicles involving slow moving heavy loads or rough terrain or both. Examples of such vehicles include a CAT 797B or a Liebherr T 282 B or a Bell loader.

Accordingly, a first aspect of the invention provides a heavy duty rim assembly for use with a moulded or cast non-inflatable tyre, the rim assembly including:

a nave having a mounting formation for mounting on a vehicle axle;

a hollow barrel around the nave, an outer surface of the barrel defining a bearing surface for bearing, in use, against a radially inner surface of a non-inflatable tyre; and

a plurality of key members around the barrel, in use providing for effective bonding and keying of the rim assembly with the non-inflatable tyre, the key members including at least one belt plate arranged to define a belt around the barrel, the belt being at least substantially concentric with and spaced apart from the barrel.

The belt may define therethrough, around its circumference, a plurality of openings providing for non-inflatable tyre material to extend therethrough, in use. It is to be understood that shear stresses and, possibly, tensile stresses induced in such tyre material extending through such apertures may, in use, resist relative movement between the non-inflatable tyre and the barrel.

The nave mounting formation may define holes spaced circumferentially about the rotational axis of the rim assembly. In use, the rim assembly may then be secured to an axle hub of a vehicle by studs or bolts fitting into said holes.

The outer surface of the barrel may be circular cylindrical.

The rim assembly may include a pair of axially spaced annular flanges at opposite ends of the barrel, extending radially beyond the barrel so that a radially inner portion of the non-inflatable tyre is in use held within a well cavity defined between the flanges and around the barrel. The flanges may define a plurality of pairs of spaced openings on opposite flanges through which bolts or shanks are receivable that extend axially between the flanges, the bolts or shanks in use thus passing through a radially inner portion of the non-inflatable tyre and also serving as key members.

The key members may include circumferentially spaced fin plates, extending transversely to a plane that is perpendicular to the axis of rotation of the rim assembly. The fin plates may be radially extending with respect to the rim assembly. The fin plates may be generally trapezium-shaped with a base portion of each being fast with and nearly spanning the width of the barrel. The belt may be secured to the barrel by the fin plates.

The key members may also include at least one annular flange around the barrel and spaced apart from opposite ends of the barrel, in a plane perpendicular to the axis of rotation of the rim assembly. The belt may be fast with the at least one annular flange.

At least some of the fin plates may have openings in them so that non-inflatable tyre material may extend therethrough, in use. It is to be understood that tensile and/or shear stresses induced in such tyre material extending through such apertures may in use resist relative movement between the non-inflatable tyre and the barrel.

According to a further aspect of the invention, there is provided a wheel which includes:

a rim assembly as above described; and

a moulded or cast non-inflatable tyre of generally annular form extending radially outwardly from the barrel.

The non-inflatable tyre may be manufactured from a synthetic plastics material or polymeric material, and may in particular be made from a curable polyurethane compound.

A middle annular portion of the non-inflatable tyre may define a plurality of circumferentially spaced draft tubes transverse to a plane that is perpendicular to the axis of rotation of the wheel and passing through the non-inflatable tyre from side to side. Opposite ends of each draft tube may be angularly offset from each other about the axis of rotation of the wheel. As such, for draft tubes that are at least substantially straight, each draft tube may be angled by up to approximately 10° relative to a plane including the rotational axis of the wheel and intersecting the draft tube midway along its length.

An outer annular portion of the non-inflatable tyre, located between the middle annular portion and an outer periphery of the non-inflatable tyre, which defines a tread, may include a circular reinforcing fabric belt incorporated into the tyre during moulding or casting, as the case may be.

According to yet a further aspect of the invention, there is provided a mould for a non-inflatable tyre, the mould including:

a base; and

a circular cylindrical side-wall extending away from the base, the side-wall defining therein a circular cylindrical cavity, with the side-wall during moulding or casting defining a radially outer surface of a non-inflatable tyre mould cavity, while an annular portion of the base immediately inside the side-wall defines a face of the non-inflatable tyre mould cavity, with a barrel of a rim assembly as defined above during moulding or casting positioned within the cylindrical cavity defining a radially inner surface of the non-inflatable tyre mould cavity.

The side-wall may include tread formations during moulding or casting for defining a tread pattern on the outer radial periphery of the non-inflatable tyre. At least some of the tread formations may be removably fastened to the side-wall.

The mould may further include a plurality of tubes locatable within a middle annular portion of the annular portion of the base immediately inside the side-wall, during moulding or casting defining draft tubes extending from side to side through the non-inflatable tyre.

According to a further aspect of the invention still, there is provided a method of manufacturing a wheel including a non-inflatable tyre, the method including:

providing a rim assembly having a plurality of key formations around a radially outer surface of the rim assembly;

positioning the rim assembly within a non-inflatable tyre mould thereby to complete a mould cavity, with an inner radial surface of the mould cavity being defined by the radially outer surface of the rim assembly;

charging a settable synthetic plastics or polymeric non-inflatable tyre material into the mould cavity;

allowing the non-inflatable tyre material to set; and

demoulding the tyre.

The rim assembly may be as described above.

The non-inflatable tyre mould may be as described above.

The method may include providing and positioning a reinforcing fabric belt within the mould cavity and around the rim assembly.

Further features of the invention will become apparent from the following description presented by way of example with reference to the accompanying diagrammatic drawings.

In the drawings:

FIG. 1 shows a three-dimensional view of a partially manufactured rim assembly in accordance with one aspect of the invention;

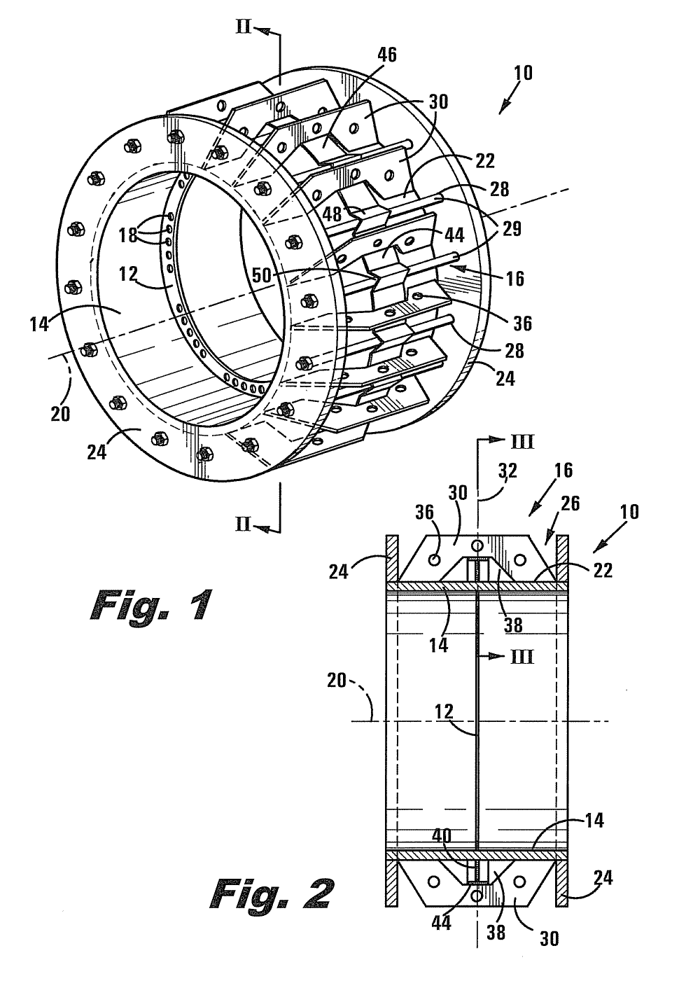

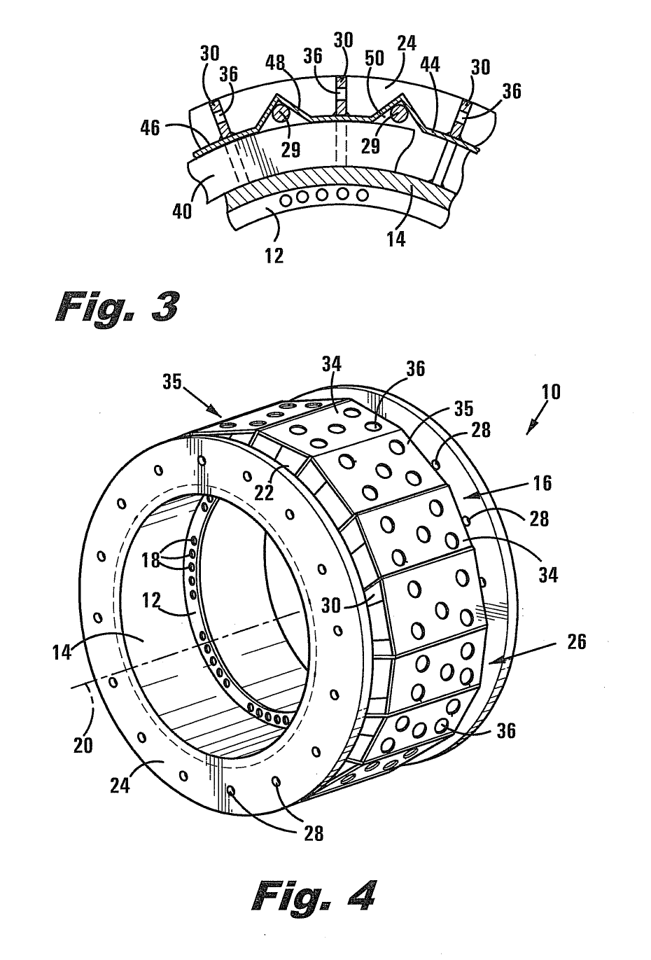

FIG. 2 shows a section taken at II-II in FIG. 1;

FIG. 3 shows a section taken at III-III in FIG. 2;

FIG. 4 shows a three-dimensional view of the rim assembly of FIG. 1 in its completed form;

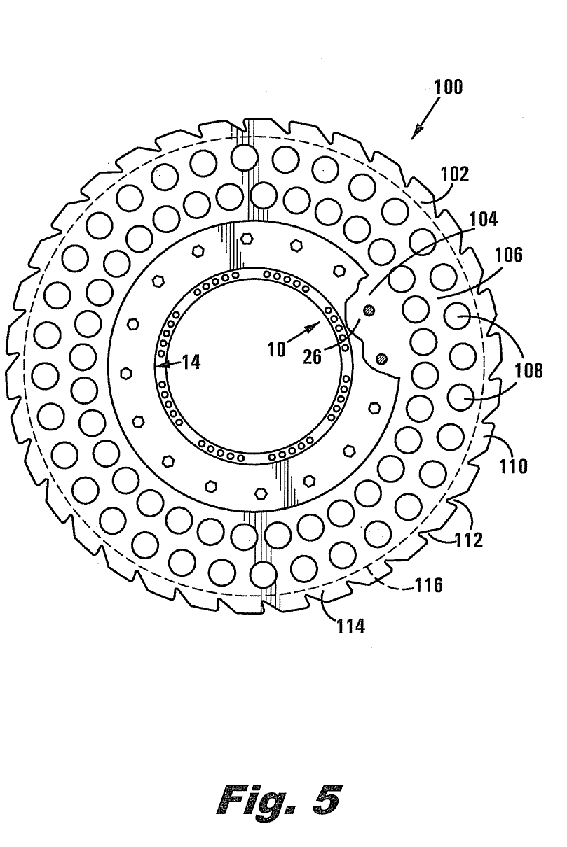

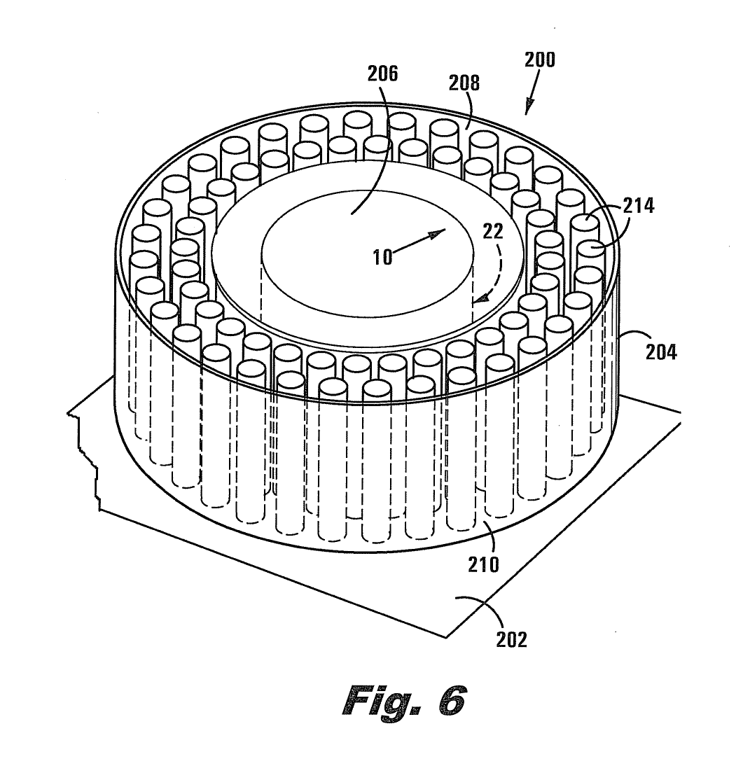

FIG. 5 shows a side elevation of a wheel in accordance with one aspect of the invention including the rim assembly of FIG. 4 and a non-inflatable tyre; and

FIG. 6 shows a three-dimensional view of a non-inflatable tyre mould in accordance with one aspect of the invention used to manufacture the non-inflatable tyre of FIG. 5.

Referring now to FIG. 1, reference numeral 10 generally indicates a partially manufactured heavy duty rim assembly for use with a moulded or cast non-inflatable tyre in accordance with the invention. The rim assembly 10 includes a nave 12, a hollow barrel 14 around the nave 12, and a plurality of key members, generally indicated by reference numeral 16, around the barrel 14. The rim assembly 10 is of carbon steel and welded construction. The steel may, for example, be DOMEX.

The nave 12 defines openings 18 circumferentially spaced about the rotational axis 20 of the rim assembly 10.

The barrel 14 extends axially on either side of the nave 12 and defines a circular cylindrical outer barrel surface 22. A pair of axially spaced annular flanges 24 is welded to and extends radially from opposite ends of the barrel 14, with a well cavity 26 being defined between the flanges 24 and around the barrel 14. In the embodiment shown, the flanges 24 are spaced about 700 mm apart. The flanges 24 define a plurality of evenly circumferentially spaced flange openings 28, arranged in axially aligned pairs on opposite flanges 24. A plurality of bolts or shanks 29 are receivable through the openings 28, extending axially between the flanges 24.

The key members 16 include a plurality of evenly circumferentially spaced radially extending fin plates 30, approximately perpendicular to a plane 32 that is perpendicular to the axis of rotation 20 of the rim assembly. The fin plates 30 are generally trapezium-shaped, with a base portion of each being welded to and nearly spanning a width of the barrel 14. The fin plates 30 are located midway between adjacent pairs of flange openings 28.

As shown in FIG. 4, the key members 16 further include a plurality of belt plates 34, extending between and welded to radially outer ends of each pair of adjacent fin plates 30, resulting in a first concentrical belt 35 around and spaced from the barrel 14.

A plurality of key member openings 36 are defined in the fin plates 30 and the belt plates 34.

The fin plates 30 and the belt plates 34 nowhere radially extend beyond the flanges 24, so that the key members 16 are within the well cavity 26.

As best shown in FIG. 2, each of the fin plates 30 defines a central trapezium-shaped opening 38 immediately adjacent to the barrel 14. The key members 16, further include a central annular flange 40, approximately parallel to the plane 32, which passes through the openings 38. The annular flange 40 nowhere radially extends to overlap with the flange openings 28. A plurality of further belt plates 44, are welded to both the annular flange 40 and the fin plates 30, resulting in a further concentrical belt 46 around and spaced from the barrel 14 inside the first concentrical belt 35. As also shown in FIG. 3, the further concentrical belt 46 includes a plurality of evenly circumferentially spaced triangular protrusions 48, each together with the annular flange 40 defining an opening 50. The openings 50 are aligned with the pairs of flange openings 28, so that the bolts or shanks 29 receivable in the flange openings 28 then extend through the openings 50.

Referring now to FIG. 5, reference numeral 100 generally indicates a wheel in accordance with one aspect of the invention. The wheel 100 includes the rim assembly 10 and a non-inflatable tyre 102 of generally annular form extending radially outwardly from the barrel 14. The non-inflatable tyre 102 is manufactured from a curable polyurethane compound, such as Premierthane L950A. In the embodiment shown, the wheel 100 has a diameter of about 2900 mm.
A radially inner portion 104 of the non-inflatable tyre 102 is held within the well cavity 26.

A middle annular portion 106 of the non-inflatable tyre 102 defines a plurality of spaced draft tubes 108 passing through the non-inflatable tyre 102 from side to side. Opposite ends of each draft tube 108 may be angularly offset from each other about the axis 20. Each draft tube 108 may particularly be angled up to approximately 10° relative to a plane (not shown) including the rotational axis 20 of the wheel 100 and intersecting the draft tube midway along its length. It will be understood that, at such an angle of about 10°, a draft tube 108 would intersect the plane 32 at about 80°.

An outer periphery 110 of the non-inflatable tyre 102 defines a tread 112. An outer annular portion 114, between the outer periphery 110 and the middle annular portion 106, includes an annular reinforcing fabric belt 116 incorporated into the tyre structure during the moulding or casting process.

Referring now to FIG. 6, reference numeral 200 generally indicates a mould for a non-inflatable tyre. The mould includes a base 202 and a side-wall 204 (typically comprising a plurality of segments) extending away from the base 202 and defining a round cylindrical cavity 206. During moulding or casting, a non-inflatable tyre mould cavity 208 is defined by the combination of the mould 200 and the outer barrel surface 22 of the rim assembly 10 positioned within the cylindrical cavity 206. The side-wall 204 defines the radially outer surface of the mould cavity 208, an annular portion 210 of the base 202 immediately inside the side-walls 204 defines an axial face of the mould cavity 208, while the outer barrel surface 22 defines a radially inner surface of the mould cavity 208. The side-wall 204 includes tread formations (not shown) during moulding or casting defining the tread 112 on the outer periphery 110 of the non-inflatable tyre 102. Some of the tread formations may be removably attached to the side wall 204, allowing the side wall 204 and the tread formations to be separated individually from a moulded or cast non-inflatable tyre.

The mould 200 further includes a plurality of tubes 214 locatable within the annular portion 210, during moulding or casting defining the draft tubes 108 passing through the non-inflatable tyre 102 from side to side.

During moulding or casting, the rim assembly 10 is positioned within the mould 200 to complete the mould cavity 208. The bolts or shanks 29 (see FIG. 1) are received through the flange openings 28 and the openings 50. The reinforcing fabric belt 116 (typically woven) is suspended within the mould cavity at a position corresponding with the outer annular portion 114. Metal surfaces of the rim assembly 10 that will be in contact with non-inflatable tyre material are coated with a chemical bonding agent. A settable curable polyurethane material is then charged into the mould cavity 208 to the desired depth and allowed to set. Hereafter the wheel is demoulded from the mould 200.

In a preferred embodiment, the settable curable polyurethane material is Quantum Premierthane L950A, prepared from a PTMEG prepolymer cured with Premiercure Series 3 curing agent. The curing is done for 30 minutes at 100° C., and post-curing after demoulding for 16 minutes at 100° C. The physical properties of the set cured polyurethane material is then approximately as set out in Table 1:

TABLE 1
Physical properties of set cured polyurethane material

| | |
|---|---|
| Hardness (Shore A) | 87 |
| 100% modulus (MPa) | 13.8 |
| 300% modulus (MPa) | 17.4 |
| Tensile strength (MPa) | 33.1 |
| % elongation | 500 |
| Tear strength (die C, kN/m) | 105.1 |
| Tear strength (ASTM D-470, | 24.5 |
| kN/m) | |
| % Bashore rebound | 44 |
| % Compressions set after 22 | 34 |
| hours at 70° C., method B | |
| Specific gravity | 1.11 |

It will be appreciated that the settable curable polyurethane material will pass through the key member openings during charging so that the non-inflatable tyre material within such openings will, in use, be subjected to shear and/or tensile stresses in resisting both axial and circumferential relative movement between the non-inflatable tyre 102 and the barrel 14.

In use, the wheel 100 is secured to an axle of a vehicle by studs or holes fitting into the openings 18 in the nave 12 of the rim assembly 10.

Upon the non-inflatable tyre 102 becoming unserviceable due to wear or damage or both, it may be removed from the rim assembly 10, possibly by a method involving the application of heat. The rim assembly 10 can then be reused.

The Inventors believe that heavy duty non-inflatable tyres in accordance with the invention have advantages over pneumatic tyres, and particularly so for truly heavy vehicles involving slow moving heavy loads or rough terrain or both. The non-inflatable tyres of the wheels in accordance with the invention have a direct static energy transfer design, and are designed to minimize non-compressive stresses induced in the non-inflatable tyres, in use. The shanks or bolts axially extending through the flange openings also aid to prevent the flanges from tearing away from the rim assembly. The draft tubes, especially when angled as described above, induce a flow of cold air through the draft tubes in use, thereby facilitating cooling of the solid tyre material.

1. A heavy duty rim assembly for use with a moulded or cast non-inflatable tire, the rim assembly comprising:
a nave having a mounting formation for mounting on a vehicle axle;
a hollow barrel around the nave, an outer surface of the barrel defining a bearing surface for bearing, in use, against a radially inner surface of a non-inflatable tire; and
a plurality of key members around the barrel in use providing for effective bonding and keying of the rim assembly with the non-inflatable tire, the key members including at least one belt plate arranged to define a belt around the barrel, the belt being at least substantially concentric with and spaced apart from the barrel.

2. A rim assembly as claimed in claim 1, in which the belt defines therethrough, around its circumference, a plurality of openings providing for non-inflatable tire material to extend therethrough, in use.

3. A rim assembly as claimed in claim 1, in which the nave mounting formation defines holes spaced circumferentially about the rotational axis of the rim assembly providing for the rim assembly to be secured to an axle hub of a vehicle by studs or bolts fitting into said holes.

4. A rim assembly as claimed in claim 1, in which the outer surface of the barrel is circular cylindrical.

5. A rim assembly as claimed in claim 1, which includes a pair of axially spaced annular flanges at opposite ends of the barrel, extending radially beyond the barrel so that a radially inner portion of the non-inflatable tire is in use held within a well cavity defined between the flanges and around the barrel.

6. A rim assembly as claimed in claim 5, in which the flanges define a plurality of pairs of spaced openings on opposite flanges through which bolts or shanks are receivable that extend axially between the flanges, the bolts or shanks in use thus passing through the radially inner portion of the non-inflatable tire and also serving as key members.

7. A rim assembly as claimed in claim 1, in which the key members include circumferentially spaced fin plates, extending transversely to a plane that is perpendicular to the axis of rotation of the rim assembly.

8. A rim assembly as claimed in claim 7, in which the fin plates are radially extending with respect to the rim assembly.

9. A rim assembly as claimed in claim 8, in which the fin plates are generally trapezium-shaped with a base portion of each being fast with and nearly spanning the width of the barrel.

10. A rim assembly as claimed in claim 7, in which the belt is secured to the barrel by the fin plates.

11. A rim assembly as claimed in claim 7, in which at least some of the fin plates have openings in them so that non-inflatable tire material extends therethrough, in use.

12. A rim assembly as claimed in claim 1, in which the key members include at least one annular flange around the barrel and spaced apart from opposite ends of the barrel, in a plane perpendicular to the axis of rotation of the rim assembly.

13. A rim assembly as claimed in claim 12, in which the belt is fast with the at least one annular flange referred to in claim 12.

14. A wheel comprising:
a heavy duty rim assembly for use with a moulded or cast non-inflatable tire, the rim assembly including:
a nave having a mounting formation for mounting on a vehicle axle;
a hollow barrel around the nave, an outer surface of the barrel defining a bearing surface for bearing, in use, against a radially inner surface of a non-inflatable tire; and
a plurality of key members around the barrel in use providing for effective bonding and keying of the rim assembly with the non-inflatable tire, the key members including at least one belt plate arranged to define a belt around the barrel, the belt being at least substantially concentric with and spaced apart from the barrel; and
a moulded or cast non-inflatable tire of generally annular form extending radially outwardly from the barrel.

15. A wheel as claimed in claim 14, in which the non-inflatable tire is manufactured from one of a synthetic plastics material and a polymeric material.

16. A wheel as claimed in claim 14, in which the non-inflatable tire is manufactured from a curable polyurethane compound.

17. A wheel as claimed in claim 14, in which a middle annular portion of the non-inflatable tire defines a plurality of circumferentially spaced draft tubes transverse to a plane that is perpendicular to the axis of rotation of the wheel and passing through the non-inflatable tire from side to side.

18. A wheel as claimed in claim 17, in which opposite ends of each draft tube are angularly offset from each other about the axis of rotation of the wheel.

19. A wheel as claimed in claim 18, in which the draft tubes are at least substantially straight and each draft tube is angled up to approximately 10° relative to a plane including the rotational axis of the wheel and intersecting the draft tube midway along its length.

20. A wheel as claimed in claim 14, in which an outer annular portion of the non-inflatable tire located between the middle annular portion and an outer periphery of the non-inflatable tire, which defines a tread, includes a circular reinforcing fabric belt incorporated into the tire during moulding or casting, as the case may be.

21. A mould for a non-inflatable tire, the mould comprising:
a base; and
a circular cylindrical side-wall extending away from the base, the side-wall defining therein a circular cylindrical cavity, with the side-wall during moulding or casting defining a radially outer surface of a non-inflatable tire mould cavity, while an annular portion of the base immediately inside the side-wall defines a face of the non-inflatable tire mould cavity, with a barrel of a rim assembly as claimed in claim 1 during moulding or casting positioned within the cylindrical cavity defining a radially inner surface of the non-inflatable tire mould cavity.

22. A mould as claimed in claim 21, in which the side-wall includes tread formations during moulding or casting for defining a tread pattern on the outer radial periphery of the non-inflatable tire.

23. A mould as claimed in claim 21, in which at least some of the tread formations are removably fastened to the side-wall.

24. A mould as claimed in claim 21, which includes a plurality of tubes locatable within a middle annular portion of the annular portion of the base immediately inside the side-wall, during moulding or casting defining draft tubes extending from side to side through the non-inflatable tire.

25. A method of manufacturing a wheel including a non-inflatable tire, the method including comprising:
providing a heavy duty rim assembly including:
a nave having a nave formation for mounting on an axle of a heavy duty vehicle;
a hollow barrel around the nave, the barrel defining a radially outer surface; and
a plurality of key members around the radially outer surface of the barrel;
positioning the rim assembly within a non-inflatable tire mould thereby to complete a mould cavity, with an inner radial surface of the mould cavity being defined by the radially outer surface of the rim assembly;
charging a settable synthetic plastics or polymeric non-inflatable tire material into the mould cavity;
allowing the non-inflatable tire material to set; and
demoulding the tire.

26. A method as claimed in claim 25, in which the rim assembly comprises:
a heavy duty rim assembly for use with a moulded or cast non-inflatable tire, the rim assembly including:
a nave having a mounting formation for mounting on a vehicle axle;
a hollow barrel around the nave, an outer surface of the barrel defining a bearing surface for bearing, in use, against a radially inner surface of a non-inflatable tire; and
a plurality of key members around the barrel in use providing for effective bonding and keying of the rim assembly with the non-inflatable tire, the key members including at least one belt plate arranged to define a belt around the barrel, the belt being at least substantially concentric with and spaced apart from the barrel.

27. A method as claimed in claim 25, in which the non-inflatable tire mould is a mould as claimed in claim 21.

28. A method as claimed in claim 25, which includes providing and positioning a reinforcing fabric belt within the mould cavity and around the rim assembly.

29. A rim assembly as claimed in claim 1, substantially as herein described with reference to and as illustrated in any of the drawings.

30. A wheel as claimed in claim 14, substantially as herein described with reference to and as illustrated in any of the drawings.
